(19) United States
(12) Patent Application Publication
(10) Pub. No.: US 2008/0172577 A1
(43) Pub. Date: Jul. 17, 2008

(54) TESTING APPARATUS AND METHOD USING TEST SCRIPT IN MOBILE COMMUNICATION SYSTEM

(75) Inventors: Eu-Jin Ha, Suwon-si (KR); In-Hoe Koo, Seoul (KR); Jung-Hoon Ahn, Suwon-si (KR)

Correspondence Address: THE FARRELL LAW FIRM, P.C., 333 EARLE OVINGTON BOULEVARD, SUITE 701, UNIONDALE, NY, 11553, US

(73) Assignee: Samsung Electronics Co., Ltd., Suwon-si (KR)

(21) Appl. No.: 11/836,611

(22) Filed: Aug. 9, 2007

(30) Foreign Application Priority Data
Aug. 9, 2006 (KR) 2006-75206

(51) Int. Cl. G06F 11/00

(52) U.S. Cl. 714/33; 714/32; 714/E11.002

(57) ABSTRACT

Provided are a testing apparatus and method using a test script in a mobile communication terminal. The testing method includes receiving a test scenario to be tested: loading the test script according to the test scenario, performing a test based on the test script; generating a test oracle during the test; and comparing the generated test oracle with the test script to determine test success or failure.

### PRIORITY

This application claims priority under 35 U.S.C. § 119 to an application filed in the Korean Intellectual Property Office on Aug. 9, 2006 and allocated Serial No. 2006-75206, the contents of which are incorporated herein by reference.

### BACKGROUND OF THE INVENTION

1. Field of the Invention

The present invention relates generally to a mobile communication system, and in particular, to a testing apparatus and method that can perform a field test using a test script in a mobile communication terminal.

2. Description of the Related Art

In general, the purpose of a program test is to detect errors in a program source code, and the purpose of a wireless protocol test is to test if a function, rather than detecting an error in the program source code, operates normally.

The w ireless protocol test can be performed using two testing methods. A first testing method is to use a dedicated test device to test the response and function of a mobile terminal with respect to a specific process in a specific field environment by applying a test script based on a standard specification. A second testing method is to determine a functional error by testing a mobile terminal in a field environment.

A testing method based on a standard specification may be divided into three processes: a test preparation process, a test execution process, and a test evaluation process. The test preparation process is to design and plan a test, and to prepare a test case for the planned test. The test execution process executes a program to be tested using the prepared test case and records the results of the test execution process. The test evaluation process determines a program error based on the results of the test execution process. The test case includes a test script representing test procedures, data necessary to perform the test script, and a test oracle for determining a program error based on the results of the test execution process.

Studies have been conducted on automatic testing methods in a program test field, and automatic generation methods of a test driver or a test stub have been developed. The test driver is a program for connecting a test program to a user interface, and the test stub is a specific test program code. In addition, an automatic generation method of the test case has been developed. However, wireless protocol testing methods are limited to two testing methods. A first testing method is a kind of a qualification testing method that applies a test script to a specific device. In general, the test script is written based on a fixed scenario and meets the standard specification. A second testing method is to test a major function in the field.

Even though the wireless protocol testing methods use the same case and the same mobile terminal, the results are often different depending on the dedicated test device. This is because individual characteristics are different depending on a model of the mobile terminal. In addition, there is a limitation in the establishment of the actual wireless environment using the dedicated test device, causing degradation of the test accuracy and reliability. Therefore, a lot of time and efforts are required to reproduce and analyze the problems.

Therefore, there is a need for a testing apparatus and method that can easily reproduce and analyze problems in the actual wireless environment and reflect the advantages of the program test technique.

### SUMMARY OF THE INVENTION

An object of the present invention is to substantially solve at least the above problems and/or disadvantages and to provide at least the advantages below. Accordingly, an object of the present invention is to provide a testing apparatus and method using a test script in a mobile communication system.

Another object of the present invention is to provide a testing apparatus and method using a program test in a mobile communication system.

A further object of the present invention is to provide an apparatus and method for performing a test in a field environment according to a test script and recording a test success or failure of a mobile communication terminal.

According to one aspect of the present invention, a testing method using a test script in a mobile communication terminal includes receiving a test scenario to be tested; loading the test script according to the test scenario, performing a test based on the test script; generating a test oracle during the test; and comparing the generated test oracle with the test script to determine test success or failure.

According to another aspect of the present invention, a testing apparatus using a test script in a mobile communication terminal includes a control unit for controlling a test oracle processing unit to generate a test oracle by performing a test using a test script generated during the test, or a test script previously set based on a test scenario loaded from a storage unit, and for comparing the generated test oracle with the test script to determine a test result: and the test oracle processing unit for generating the test oracle, based on instruction and information provided from the control unit, and for generating a test log related to the test.

### BRIEF DESCRIPTION OF THE DRAWINGS

The above and other objects, features and advantages of the present invention will become more apparent from the following detailed description when taken in conjunction with the accompanying drawings in which:

FIG. 1 is a conceptual diagram of a mobile communication system according to the present invention;

FIG. 2 is a block diagram of a mobile communication terminal according to the present invention:

FIG. 3 is a flowchart illustrating a testing method using a test script in a mobile communication terminal according to the present invention; and

FIG. 4 is a block diagram of a testing apparatus using a test script according to the present invention.

### DETAILED DESCRIPTION OF THE PREFERRED EMBODIMENTS

Preferred embodiments of the present invention will be described herein below with reference to the accompanying drawings. In the following description, well-known functions or constructions are not described in detail since they would obscure the invention in unnecessary detail.

The testing apparatus and method according to the present invention can efficiently perform a protocol test by applying a test script, a test stub, and a test oracle to a wireless protocol code. The test script makes a reference point clear, based on a standard specification, and is created in a minimal process in order not to lower the efficiency of a program due to the test code in a wireless environment. Specifically, the range of the test oracle is minimized, taking into consideration complexity of a wireless protocol process. In addition, the testing apparatus and method according to the present invention can provide the test results to a developer in real time by displaying debug data. Hence, the developer can easily detect a defective location and perform an automatic analysis.

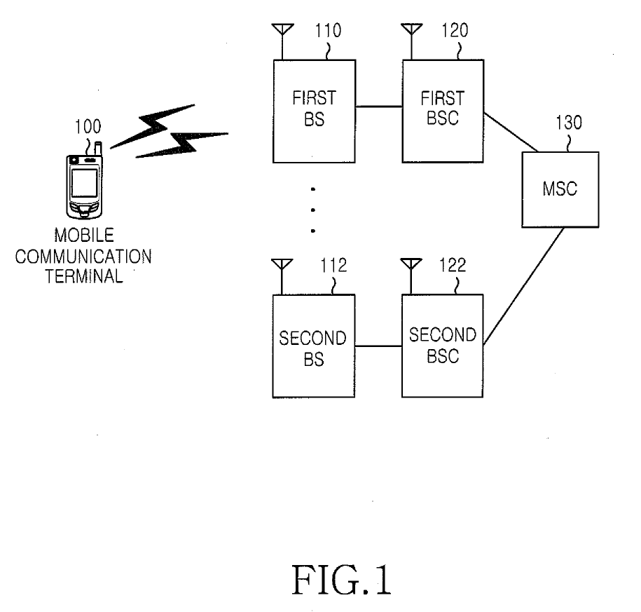

FIG. 1 is a conceptual diagram of a mobile communication system according to the present invention.

Referring to FIG. 1, a mobile communication terminal 100 transmits/receives call signals and data to/from a mobile switching center (MSC) 130 through a first base station controller (BSC) 120 and a first base station (BS) 110. If the mobile communication terminal 100 moves into a service area of a second BS 112 and a second BSC 122, it performs a hand-over process to the second BS 112 and transmits/receives call signals and data.

In this case, a program for testing the wireless communication protocol is installed in the mobile communication terminal 100, and a test script for a specific function of the wireless communication protocol is executed. Examples of the specific function may include handover, call drop, cell selection, and cell reselection. Then, the test script is compared with a test oracle generated based on the standard specification. The test result is determined according to the result of the comparison. Therefore, problem reproduction and analysis are easy in an actual wireless environment.

The test script and the test oracle are based on test scenario information complying with the standard specification. The capacity of software in the mobile communication terminal is still limited relative to other electronic devices. Specifically, functions that must be rapidly processed for example, real-time data transmission/reception functions and call related functions, have a great influence on the test because a lot of capacity and time is taken to generate the test script and the test oracle. Therefore, restrictive and concrete test scenarios are required. The concrete test scenario refers to a scenario in which a function for a frequent error occurring in a mobile communication terminal is previously created based on a standard specification. The test script must be defined in a source code of a program and a simple script can be generated through the test scenario. This is because the variation of the procedures is more important than the program source code itself in the wireless communication protocol.

Although a conventional standard specification-based test method is achieved through comparison with a reference code generated based on the standard specification, the test method according to the present invention previously generates the test result, based on the standard specification, through simulations of the test oracle instead of the reference code, and then performs a test by determining if the program of the mobile communication terminal operates normally. Therefore, an approximate problem occurrence location can be analyzed.

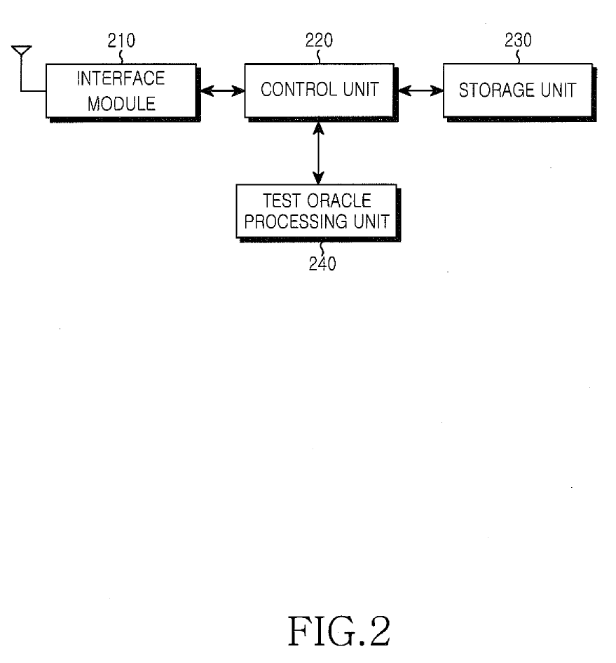

FIG. 2 is a block diagram of a mobile communication system according to the present invention.

Referring to FIG. 2, a control unit 220 performs an overall control of a test operation based on a test scenario. In addition, the control unit 220 loads a test script based on a specific test scenario from a storage unit 230 to perform a test according to the specific test scenario. The control unit 220 controls a test oracle processing unit 240 to generate a test oracle for a running test. The type of test scenario to be executed may be selected by a user through a man machine interface (MMI). Moreover, the control unit 220 may directly generate a simple script. The control unit 220 compares the generated test oracle with the test script. A test result specified in the test script is recorded in the generated test oracle. Therefore, the control unit 220 determines a test success or failure by comparing the test script with the test oracle. The control unit 220 creates a test log when the test fails.

The test oracle processing unit 240 generates the test oracle when the test is performed based on the instruction and information provided from the control unit 220.

The storage unit 230 stores a program for controlling an overall operation of the mobile communication terminal and temporarily stores data generated during the program operation. Specifically, the storage unit 230 stores the test scenario, the test script, the test oracle, and the test log.

An interface module 210 communicates with other nodes and includes a radio frequency (RF) processor and a baseband processor. The RF processor down-converts an RF signal received through the antenna to provide the down-converted signal to the baseband processor, and up-converts a baseband signal from the baseband processor into an RF signal, which can be transmitted over air through the antenna.

The control unit 220 may be configured to perform the function of the test oracle processing unit 240. In FIG. 2, the components are separately illustrated so as to differentiate their functions. Therefore, in real products, the control unit 220 can be designed to perform all or a part of the function of the test oracle processing unit 240.

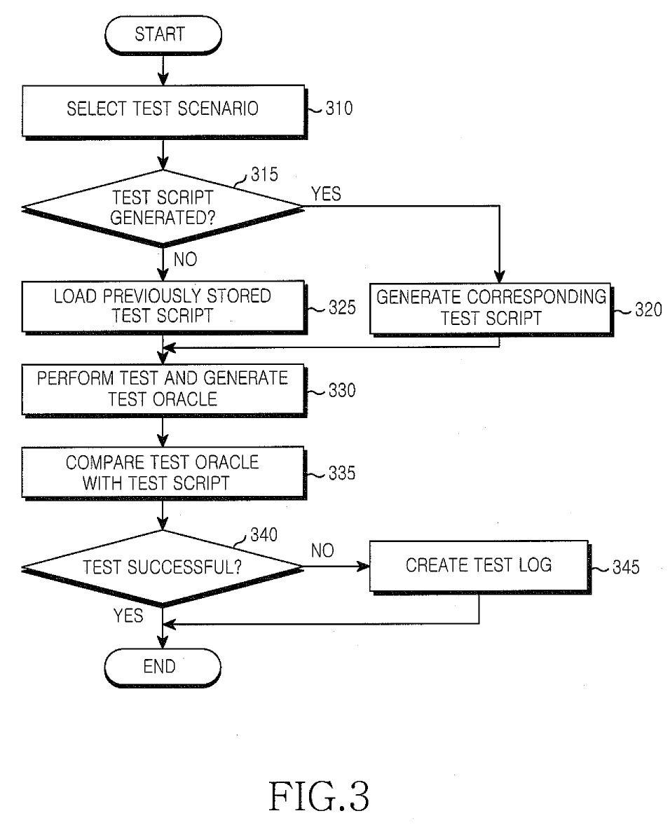

FIG. 3 is a flowchart illustrating a testing procedure using a test script in a mobile communication terminal according to the present invention.

Referring to FIG. 3, in step 310, the control unit 220 receives a test scenario selected from the user. In step 315, the control unit 220 determines if the selected test scenario requires that a test script be generated.

If the test scenario requires that the test script is to be generated, the control unit 220 proceeds to step 320 to generate a test script according to the test scenario.

If the test scenario does not require that the test script is to be generated, the control unit 220 proceeds to step 325 to load a test script previously stored according to the test scenario in the storage unit 230.

In step 330, the control unit 220 performs a test according to the test scenario and controls the test oracle processing unit 240 to generate the test oracle.

In step 335, the control unit 220 compares the generated test oracle with the test script. The generated test oracle stores the test result specified in the test script. Therefore, in step 340 the control unit 220 determines a test success or failure by comparing the test script with the test oracle.

When the test result is the test failure in step 340, the control unit 220 creates a test log in step 345. The test log may include a test failure item and a failure location.

Thereafter, the control unit 220 ends the procedure of the present invention.

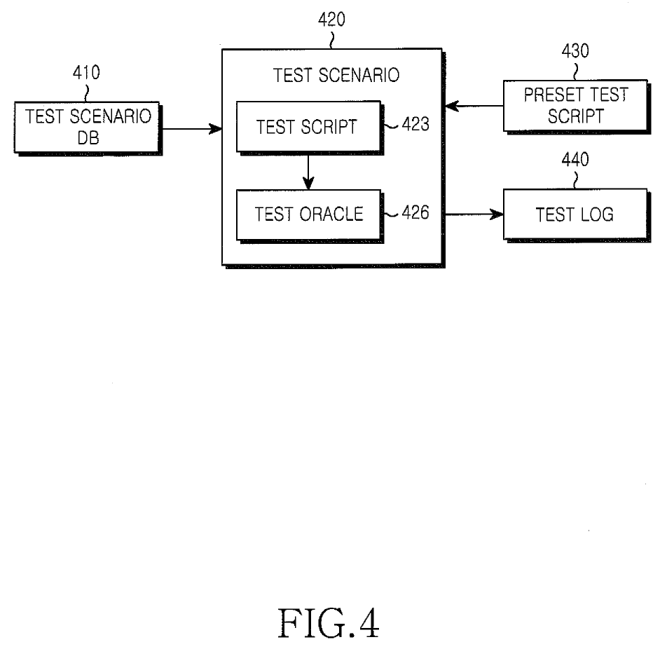

FIG. 4 is a block diagram of a testing apparatus using a test script according to the present invention.

Referring to FIG. 4, a test scenario 420 to be tested is loaded from a test scenario database (DB) 410. The test scenario DB 410 may be provided in a specific device disposed outside the mobile communication terminal.

The test scenario 420 loaded from the test scenario DB 410 is stored in the mobile communication terminal. The mobile communication terminal may generate a test script 423 from the test scenario 420. In addition, a preset test script 430 may be loaded.

A test oracle 426 is generated during the test. A test log 440 is generated when the test fails. Real-time monitoring is possible by a debug function using the test log 440 or the test oracle 426.

Moreover, the mobile communication terminal can download and analyze the test log 440 or the test oracle 426.

The testing apparatus and method according to the present invention can test problems frequently occurring in the field, without using additional devices. In addition, the testing apparatus and method according to the present invention are not limited to the number of mobile communication terminals. Because the test oracle is generated using the test script based on the test scenario, the present invention can be applied to various problems by changing and modifying the test scenario according to a specific problem. Therefore, the problem occurrence locations can be determined and analyzed. Consequently, even non-protocol engineers can promptly grasp and cope with the problems.

Alternate embodiments of the present invention can also comprise computer readable codes on a computer readable medium. The computer readable medium includes any data storage device that can store data that can be read by a computer system. Examples of a computer readable medium include magnetic storage media (such as ROM. floppy disks, and hard disks, among others), optical recording media (such as CD-ROMs or DVDs), and storage mechanisms such as carrier waves (such as transmission through the Internet). The computer readable medium can also be distributed over network coupled computer systems so that the computer readable code is stored and executed in a distributed fashion. Also, functional programs, codes, and code segments for accomplishing the present invention can be construed by programmers of ordinary skill in the art to which the present invention pertains.

While the invention has been shown and described with reference to certain preferred embodiments thereof it will be understood by those skilled in the art that various changes in form and details may be made therein without departing from the spirit and scope of the invention as defined by the appended claims.

What is claimed is:

1. A testing method using a test script in a mobile communication terminal, comprising:
receiving a test scenario to be tested;
loading the test script according to the test scenario;
performing a test based on the test script;
generating a test oracle during the test; and
comparing the generated test oracle with the test script to determine test success or failure.

2. The testing method of claim 1, further comprising, for generating a test log related to the test result.

3. The testing method of claim 1, wherein the test script is one of a test script previously set in a database and a test script generated during the test.

4. The testing method of claim 1, wherein the test oracle is capable of downloading into an external device.

5. The testing method of claim 1, wherein the test scenario and the test script are based on a standard specification.

6. A testing apparatus using a test script in a mobile communication terminal, comprising:
a control unit for controlling a test oracle processing unit to generate a test oracle by performing a test using one of a test script generated during the test and a test script previously set based on a test scenario loaded from a storage unit, and for comparing the generated test oracle with the test script to determine a test result: and
the test oracle processing unit for generating the test oracle, based on instruction and information provided from the control unit, and for generating a test log related to the test result.

7. The testing apparatus of claim 6, wherein the test oracle is capable of downloading into an external device.

8. The testing apparatus of claim 6, wherein the test scenario and the test script are based on a standard specification.

9. The testing apparatus of claim 6, wherein the test script is one of a test script previously set in a database and a test script generated during the test.

10. A Computer-readable recording medium having recorded thereon a program for testing using a test script in a mobile communication terminal, comprising;
a first code segment for receiving a test scenario to be tested:
a second code segment for loading the test script according to the test scenario;
a third code segment for performing a test based on the test script;
a fourth code segment for generating a test oracle during the test;
a fifth code segment for comparing the generated test oracle with the test script to determine test success or failure; and
a sixth code segment for generating a test log related to the test result.

11. The computer-readable recording medium of claim 10, wherein the test oracle is capable of downloading into an external, device.

12. The computer-readable recording medium of claim 10, wherein the test scenario and the test script are based on a standard specification.

13. The computer-readable recording medium of claim 10, wherein the test oracle is capable of downloading into an external device.

14. A test system using a test script in a mobile communication terminal, comprising:
a mobile station for generating a test oracle by performing a test using one of a test script generated during the test and a test script previously set based on a test scenario loaded from a storage unit, for comparing the generated test oracle with the test script to determine a test result and for generating a test log related to the test result; and
a base station for communicating with the mobile station and providing the mobile station with an interface for Mobile Switching Center(MSC).

15. The test system of claim 14, wherein the test oracle is capable of downloading into an external device.

16. The test system of claim 14, wherein the test scenario and the test script are based on a standard specification.

17. The test system of claim 14, wherein the test script is one of a test script previously set in a database and a test script generated during the test.
